(19) United States
(12) Patent Application Publication
(10) Pub. No.: US 2005/0127622 A1
(43) Pub. Date: Jun. 16, 2005

(54) Mobile display station

(75) Inventor: William R. Beyer, Bentonville, AR (US)

Correspondence Address: BELASCO, JACOBS & TOWNSLEY LLP;HOWARD HUGHES CENTER, 6100 CENTER DRIVE, SUITE 630, LOS ANGELES, CA, 90045, US

(73) Assignee: Retailtainment Inc.

(21) Appl. No.: 11/072,063

(22) Filed: Mar. 4, 2005

(51) Int. Cl. B62D 39/00

(52) U.S. Cl. 280/33.992

(57) ABSTRACT

A mobile display station comprising a box having a top, a front, and two sides, which is adapted to fit over a standard market shopping cart. Preferably there is a door cut into and a tray attached to the top. If desired means can be provided for attaching the box to the cart. Preferably, there is a pole, inserted through a hole in the top, with a sign board attached to its upper end. The lower end of the pole rests on the bottom of the cart and is attached to the cart. Preferably the front and sides of the box and both sides of the sign board carry advertising.

### BACKGROUND OF THE INVENTION

The present invention relates to the field of retail promotion and more particularly to mobile display stations for promoting products. This invention can be used any retail location such as supermarkets, grocery stores, mass stores and club stores.

Manufacturers regularly promote their products to shoppers in supermarkets. As shoppers wander up and down the aisles, they frequently encounter people behind tables or other kinds of displays from which they are encouraged to sample products. The manufacturers are hoping that the shoppers will like the products they have sampled and will purchase one or more packages on that or subsequent shopping trips. Clearly, this is a successful marketing technique.

However, this technique suffers from a major deficiency. The tables or displays are stationary. Shoppers must pass near the tables or displays in order to be exposed to the products being promoted. If shoppers do not pass near the tables or displays they will not be exposed to the products being promoted.

Development of a promotional display which can travel to the shopper rather than waiting for the shopper to pass by represents a great improvement in the field of product marketing and satisfies a long felt need of the manufacturer and marketing professions.

### SUMMARY OF THE INVENTION

The present invention is a mobile display station comprising a box having a top, a front, and two sides. The box is adapted to fit over a wheeled, market shopping cart. Preferably there is a door cut into the top and a tray attached to the top. If desired means can be provided for attaching the box to the cart. Preferably, there is a pole, inserted through a hole in the top, with a sign board attached to its upper end. The lower end of the pole rests on the bottom of the cart and is attached to the rear or side of the cart. Preferably the front and sides of the box and both sides of the sign board carry advertising.

The mobile display station of this invention is fabricated in the following manner. First, a box, sized and shaped to fit over a standard market shopping cart, having top, a front and two sides is fabricated. Preferably, advertising is applied to the front and both sides. A hole is cut into the top. A door is cut into the top, preferably towards the front. A means for grasping the door, for example a finger hole, is cut into the door. Next a tray is fabricated and attached to the top, preferably to the rear of the door. Then the box is placed over a shopping cart. If desired, a simple means for attaching the box to the cart may be utilized.

A pole with diameter to fit through the hole is obtained and a sign board attached to its upper end. Preferably the sign board carries advertising on both sided. The lower end is slid through the hole until it rests on the bottom of the cart and is attached to either the side or the rear of the cart.

This invention is used in promoting goods by: placing the goods within the tray; optionally storing more goods within the shopping cart; and rolling the cart to a location where a shopper is shopping. Goods are then removed from the tray and offered to the shopper. As needed or desired, the tray may be replenished with goods stored within the shopping cart.

An appreciation of the other aims and objectives of the present invention and an understanding of it may be achieved by referring to the accompanying drawings and description of a preferred embodiment.

### BRIEF DESCRIPTION OF THE DRAWINGS

FIG. 1 is a perspective view of the mobile display station of this invention.

FIG. 2 is a top view of the mobile display station of this invention with the pole and sign board not included.

FIG. 3 is a side view of the mobile display station of this invention, attached to a wheeled market shopping cart with a door open. The view from the other side is a mirror image of this view.

FIG. 4 is a detail view from the rear of the shopping cart illustrating attachment of the pole to the cart.

### DETAILED DESCRIPTION OF THE PREFERRED EMBODIMENT

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

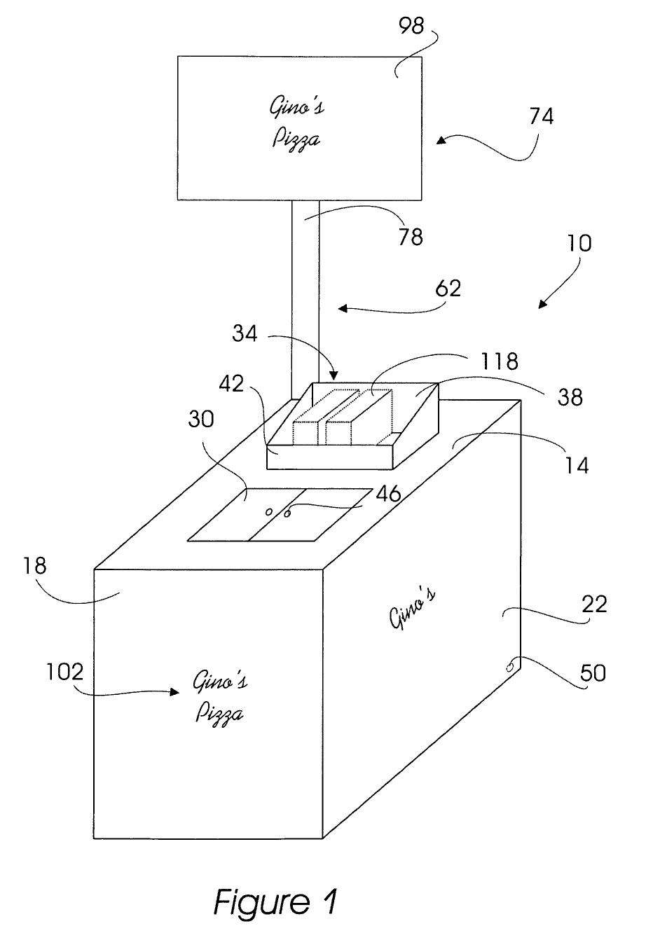

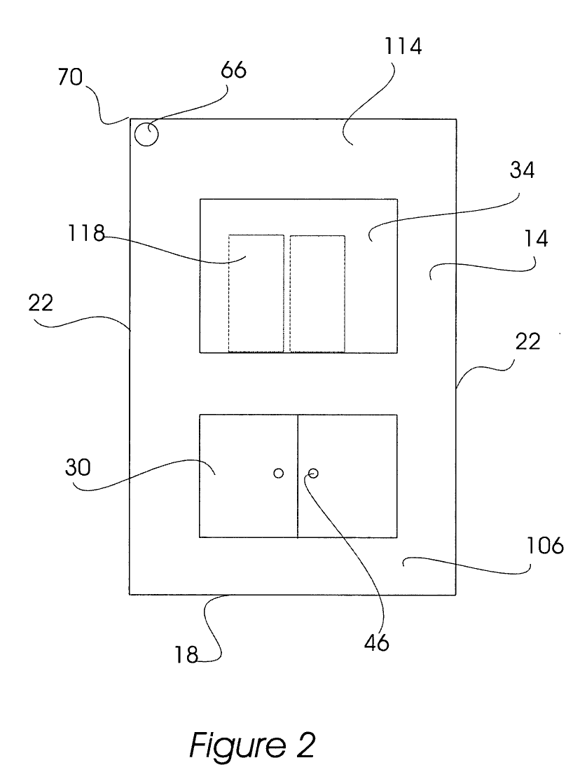

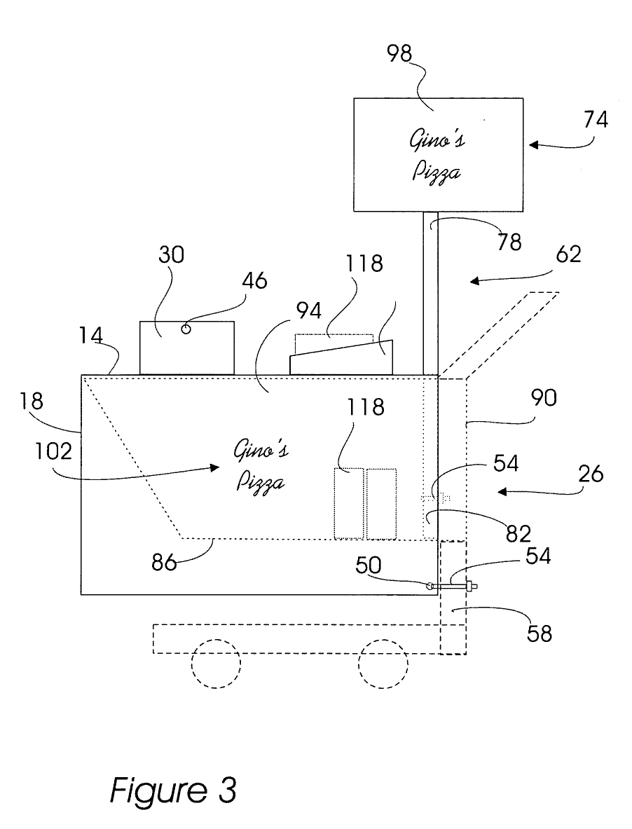

Referring to FIGS. 1, 2 and 3, the mobile display station of the present invention is a box 10 having a top 14, a front 18, and two opposing sides 22. Although, a box 10 with a rectangular front 18 and rectangular sides 22 is illustrated in the Figures, it will be recognized that the lower and rear extremities of the box 10 could be any desired decorative shape. The box 10 is adapted to fit over a wheeled, market shopping cart 26. Preferably there is a door 30 cut into and a tray 34 attached to the top 14. Preferably, the tray 14 is placed to the rear of the door 30 but their positions could certainly be reversed. Preferably, the rear 38 of the tray 34 is higher than its front 42. Preferably means are provided for grasping the door 30 so that it can be opened. This can be as simple as a finger hole 46 cut into the door 30. But clearly, any type of standard handle could also be used.

If desired means can be provided for attaching the box 10 to the cart 26. This can be as simple as a hole 50 cut into the side 22 with an electrical tie 22 looped through the hole 50 and fastened around one of the cart members 58. However, those familiar with the art to which this invention pertains will appreciate that any other convenient means, such as a nut and bolt, a plastic fastener or bailing wire, could be used.

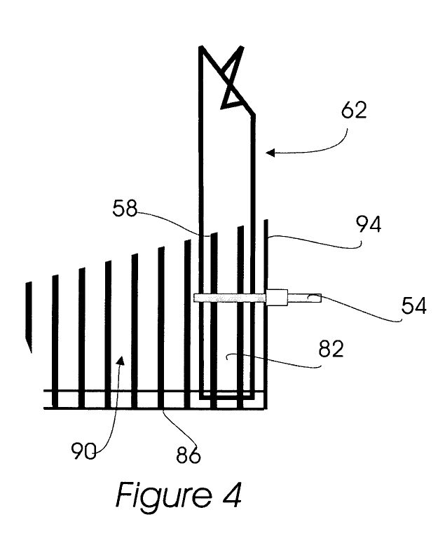

Preferably, there is a pole 62, inserted through a hole 66 in the top 14, with a sign board 74 attached to its upper end 78. Preferably the hole 66 is near a rear corner 70 although a front corner or anywhere along a side would be a viable alternative. The lower end 82 of the pole 62 rests on the bottom 86 of the cart 26 and is attached to the cart 26. Attachment is again preferably made by means of an electrical tie 54 fastened around the pole and one or more members 58 of the cart 26. FIG. 4 better illustrates this means of attachment. However, any convenient means, such as a nut and a bolt, a clamp or baling wire could also be used. The pole 62 can be made of any convenient material such as wood, metal, fiberglass or plastic.

Preferably the front 18 and sides 22 of the box 10 and both sides 98 of the sign board 74 carry advertising 102. The box 10 and sign board 98 can be made of any convenient material. The most convenient material is cardboard of sufficient thickness. However, wood, metal or plastic could also be used. If cardboard is used then the doors 30 can simply be cut around 3 sides. In this way they will be self hinged. Alternatively, any type of hinge could be used to attach the door 30 to the top 14.

The mobile display station of this invention is preferably fabricated in the following manner. First, a box 10, sized and shaped to fit over a wheeled, market shopping cart, having a top 14, a front 18 and two sides 22 is fabricated. Preferably, advertising 102 is applied to the front 18 and both sides 22. A hole 66 is cut into the top 14, preferably near a corner rear 70, and a door 30 is cut into the top 14, preferably towards the front 106. A means for grasping the door, for example a finger hole 46 is cut into the door 30. If desired, a hole 50 is cut into one or both of the sides. Next a tray 34 is fabricated and attached to the top 14, preferably to the rear 114 of the top 14. Then the box 10 is placed over a shopping cart 26 and, if desired, an electrical tie 54 is used to attach the box to the cart 26 through the hole 50. Again, any other convenient means, such as a nut and bolt or bailing wire, could be used.

A pole 62 with diameter to fit through the hole 66 is obtained and a sign board 74 attached to its upper end 78. Preferably the sign board 74 carries advertising 102 on both sides 98. The lower end 82 is slid through the hole 66 until it rests on the bottom 86 of the cart 26 and is attached to either the side 94 or the rear 90 of the cart 26. Again, an electrical tie 54 is used to attach the pole 62 to the cart 26. See FIG. 4. However, any convenient means, such as a nut and a bolt, a clamp or baling wire could also be used.

This invention is preferably used in promoting goods 118 by: placing the goods 118 within the tray 34; storing more goods 118 within the shopping cart 26; and rolling the cart to a location where a shopper is shopping. Goods 118 are then removed from the tray 34 and offered to the shopper. As needed or desired, the tray 34 may be replenished with goods 118 stored within the shopping cart 26. Alternatively, goods 118 may simply be displayed on the top 14 of the box, with or without the tray 34. In a further alternative, goods 118 are not offered to the shopper. In an additional alternative this invention 10 may be utilized with cold or frozen goods 118 by the simple expedient of placing a cooler filled with ice or dry ice within the cart 26 and storing the goods 118 within the cooler.

The following reference numerals are used on FIGS. 1 through 4:
10 Box
14 Top of box
18 Front of box
22 Side of box
26 Wheeled, shopping cart
30 Door
34 Tray
38 Rear of tray
42 Front of tray
46 Door opening means
50 Hole in side
54 Electrical tie
58 Cart member
62 Pole
66 Hole in top
70 Rear corner of top
74 Sign board
78 Upper end of pole
82 Lower end of pole
86 Bottom of cart
90 Rear of cart
94 Side of cart
98 Side of sign board
102 Advertising
106 Front of top
114 Rear of top
118 Goods

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

1. A mobile display station comprising a box having a top, a front, and a side; said box being adapted to fit over a shopping cart; said shopping cart having a bottom.

2. A mobile display station as claimed in claim 1 further comprising a door within said top.

3. A mobile display station as claimed in claim 1 further comprising a tray attached to said top.

4. A mobile display station as claimed in claim 1 in which said top additionally has a hole through it, further comprising;
a) a pole inserted through said hole; said pole having an upper end and a lower end; said lower end resting on said bottom and attached to said shopping cart; and
b) a sign board attached to said upper end.

5. A mobile display station as claimed in claim 1 in which said front and side carry advertising.

6. A mobile display station as claimed in claim 5 in which said sign board carries advertising.

7. A mobile display station as claimed in claim 1 further comprising a means for attaching said box to said shopping cart.

8. A mobile display station comprising:
a) a box having a top, a front, and two sides; said box being adapted to fit over a shopping cart; said shopping cart having a bottom;
b) a door within said top; and
c) a tray attached to said top.

9. A mobile display station as claimed in claim 8 in which said top additionally has a hole through it, further comprising;
a) a pole inserted through said hole; said pole having an upper end and a lower end; said lower end resting on said bottom and attached to said shopping cart; whereby said pole is approximately vertical; and
b) a sign board attached to said upper end.

10. A mobile display station as claimed in claim 8 in which said front and sides carry advertising.

11. A mobile display station as claimed in claim 9 in which said sign board carries advertising.

12. A mobile display station as claimed in claim 8 further comprising a means for attaching said box to said shopping cart.

13. A mobile display station comprising:
a) a box having a top, a front, and two sides; said box being adapted to fit over a shopping cart; said shopping cart having a bottom; said top having a hole through it;
b) a door within said top;
c) a tray attached to said top;
d) a pole inserted through said hole; said pole having an upper end and a lower end; said lower end resting on said bottom and attached to said shopping cart; and
e) a sign board attached to said upper end.

14. A mobile display station as claimed in claim 13 in which said front, sides and sign board carry advertising.

15. A mobile display station as claimed in claim 13 further comprising a means for attaching said box to said shopping cart.

16. A method of fabricating a mobile display station comprising the steps of:
a) fabricating a box having a top, a front, and two sides; said box being adapted to fit over a shopping cart; said shopping cart having a bottom;
b) cutting a hole through said top;
c) cutting a door into said top;
d) fabricating a tray;
e) attaching said tray to said top;
f) placing said box over a shopping cart;
g) providing a pole having an upper end and a lower end;
h) fabricating a sign board;
i) attaching said sign board to said upper end;
j) inserting said lower end through said hole so that said lower end rests on said bottom; and
k) attaching said lower end to said shopping cart.

17. A method as claimed in claim 16 further comprising the step of applying advertising to said front, sides and sign board.

18. A method as claimed in claim 16 further comprising the step of attaching said box to said shopping cart.

19. A method of promoting goods comprising the steps of:
a) fabricating a box having a top, a front, and two sides; said box being adapted to fit over a shopping cart; said shopping cart having a bottom;
b) cutting a hole through said top;
c) cutting a door into said top;
d) fabricating a tray;
e) attaching said tray to said top;
f) placing said box over a shopping cart;
g) providing a pole having an upper end and a lower end;
h) fabricating a sign board;
i) attaching said sign board to said upper end;
j) inserting said lower end through said hole so that said lower end rests on said bottom;
k) attaching said lower end to said shopping cart; and
l) placing said goods within said tray.
whereby goods are moved to a location where a shopper is shopping and goods may be removed from said tray and presented to said shopper;

20. A method as claimed in claim 19 further comprising the step of storing more goods within said shopping cart whereby said tray may be replenished with goods stored within said shopping cart.

21. A method as claimed in claim 19 further comprising the step of applying advertising to said front, sides and sign board.

22. A method as claimed in claim 19 further comprising the step of attaching said box to said shopping cart.
